(19) United States
(12) Patent Application Publication
(10) Pub. No.: US 2026/0012238 A1
(43) Pub. Date: Jan. 8, 2026

(54) METHOD AND APPARATUS FOR PORT ADAPTATION INDICATION

(71) Applicant: LENOVO (BEIJING) LIMITED, Beijing (CN)

(72) Inventors: Yingying Li, Beijing (CN); Hongmei Liu, Beijing (CN); Zhi Yan, Beijing (CN); Yuantao Zhang, Beijing (CN); Haiming Wang, Beijing (CN)

(21) Appl. No.: 19/112,525

(22) PCT Filed: Sep. 30, 2022
(86) PCT No.: PCT/CN2022/123388

§ 371 Date: Mar. 17, 2025

(51) Int. Cl. H04B 7/06; H04J 13/00; H04L 5/00

(52) U.S. Cl. CPC H04B 7/0626; H04L 5/0051; H04J 13/00

(57) ABSTRACT

Methods and apparatuses for port adaptation indication are provided. A UE may receive a configuration associated with a channel state information (CSI) report. wherein the configuration indicates a number of ports for the CSI report (611): receive an indication associated with port adaptation (613): and generate the CSI report based on the configuration and the indication (615).

### TECHNICAL FIELD

Embodiments of the present disclosure generally relate to wireless communication technology, and more particularly to port adaptation indication.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

A BS may be equipped with massive antenna elements for high data rate or massive users. To save the energy consumed by the network, the network can mute part of ports semi-static. However, the semi-static adaptation cannot reflect channel or data traffic. There is a need for introducing a dynamic adaptation of logical antenna port. In addition, various issues may arise when such dynamic adaptation mechanism is employed, and thus solutions for solving these issues are desired.

### SUMMARY

Some embodiments of the present disclosure provide a user equipment (UE). The UE may include a transceiver, and a processor coupled to the transceiver. The processor may be configured to: receive a configuration associated with a channel state information (CSI) report, wherein the configuration indicates a number of ports for the CSI report; receive an indication associated with port adaptation; and generate the CSI report based on the configuration and the indication.

In some embodiments of the present disclosure, the indication indicates at least one symbol which a muted port(s) is associated with.

In some embodiments of the present disclosure, the indication indicates at least one of: an index(es) of the at least one symbol; a value of a first symbol in time domain parameter associated with the CSI report; or a value of a start symbol position parameter associated with the CSI report.

In some embodiments of the present disclosure, the processor is further configured to determine at least one of: a port(s) which locates in a symbol(s) having the indicated index(es) is muted; a port(s) in a code division multiplexing (CDM) group associated with the value of the first symbol in time domain parameter is muted; or a port(s) in a CDM group starting from the start symbol position is muted.

In some embodiments of the present disclosure, generating the CSI report based on the configuration and the indication comprises at least one of the following: in the case that an antenna element and port mapping of a CSI reference signal (CSI-RS) resource associated with the CSI report is not changed after the port adaptation is applied, maintaining the CSI report to be transmitted after the port adaptation is applied; in the case that all time instances of the CSI-RS resource associated with the CSI report precedes a time when the port adaptation is applied and the antenna element and port mapping of the CSI-RS resource associated with the CSI report is changed after the port adaptation is applied, dropping the CSI report to be transmitted after the port adaptation is applied; or in the case that the antenna element and port mapping of the CSI-RS resource associated with the CSI report is changed after the port adaptation is applied, generating the CSI report to be transmitted after the port adaptation is applied based on a time instance of the CSI-RS resource associated with the CSI report that occurs after the time when the port adaptation is applied.

In some embodiments of the present disclosure, the processor is further configured to determine an adapted port number or a lowest muted port index based on the indication. In some embodiments of the present disclosure, the antenna element and port mapping of the CSI-RS resource associated with the CSI report is determined to be changed in response to at least one of the following: the number of ports for the CSI report is greater than the adapted port number, the maximum index of the ports for the CSI report is greater than or equal to the lowest muted port index, a type 2 port adaptation is applied, or a part of spatial elements associated with at least one of the ports for the CSI report is disabled.

Some embodiments of the present disclosure provide a base station (BS). The BS may include a transceiver, and a processor coupled to the transceiver. The processor may be configured to: transmit, to a user equipment (UE), a configuration associated with a channel state information (CSI) report, wherein the configuration indicates a number of ports for the CSI report; transmit, to the UE, an indication associated with port adaptation; and transmit, to the UE, a CSI reference signal (CSI-RS) on a CSI-RS resource for the CSI report in response to the port adaptation being applied, wherein the CSI-RS resource is determined based on the configuration and the indication.

In some embodiments of the present disclosure, the configuration indicates a plurality of CSI-RS resources with different numbers of ports for channel measurement for the CSI report or a plurality of CSI reports, each of which is configured with a CSI-RS with different numbers of ports for channel measurement, and the indication indicates an adapted port number.

In some embodiments of the present disclosure, the processor is further configured to perform at least one of the following: in response to the port adaptation being applied, determine whether a port number of an active CSI-RS resource or an active CSI report for the UE is greater than the adapted port number; in response to the port number of the active CSI-RS resource or the active CSI report for the UE being equal to or smaller than the adapted port number, maintain the active CSI-RS resource or the active CSI report for the UE; in response to the port number of the active CSI-RS resource or the active CSI report for the UE being greater than the adapted port number, deactivate the active CSI-RS resource or the active CSI report for the UE; or in response to the port number of the active CSI-RS resource or the active CSI report for the UE being greater than the adapted port number, activate a CSI-RS resource for the UE from the plurality of CSI-RS resources with the same number of port as the adapted port number, or activate a CSI report for the UE from the plurality of CSI reports with the same number of port as the adapted port number.

In some embodiments of the present disclosure, the configuration indicates a plurality of CSI-RS resources with different numbers of ports for channel measurement for the CSI report or a plurality of CSI reports, each of which is configured with a CSI-RS with different numbers of ports for channel measurement, and the indication indicates a CSI-RS resource from the plurality of CSI-RS resources or a CSI report from the plurality of CSI reports.

In some embodiments of the present disclosure, transmitting the CSI-RS comprises transmitting the CSI-RS on the indicated CSI-RS resource or on a CSI-RS resource for the indicated CSI report.

In some embodiments of the present disclosure, the indication indicates at least one muted port.

In some embodiments of the present disclosure, the indication comprises a first plurality of bits, each of which corresponds to a port. In some embodiments of the present disclosure, wherein the indication comprises a second plurality of bits, each of which corresponds to a port group.

In some embodiments of the present disclosure, the port groups are determined based on a code division multiplexing (CDM) group configuration for the CSI report. In some embodiments of the present disclosure, the port groups are predefined. In some embodiments of the present disclosure, the port groups are defined based on configurable port numbers.

In some embodiments of the present disclosure, the indication indicates at least one symbol which a muted port(s) is associated with.

In some embodiments of the present disclosure, the indication indicates at least one of: an index(es) of the at least one symbol; a value of a first symbol in time domain parameter associated with the CSI report; or a value of a start symbol position parameter associated with the CSI report.

In some embodiments of the present disclosure, the processor is further configured to determine at least one of: a port(s) which locates in a symbol(s) having the indicated index(es) is muted; a port(s) in a code division multiplexing (CDM) group associated with the value of the first symbol in time domain parameter is muted; or a port(s) in a CDM group starting from the start symbol position is muted.

In some embodiments of the present disclosure, the indication indicates an adapted port number and at least one lowest muted port index.

In some embodiments of the present disclosure, the processor is further configured to determine at least one muted port for the CSI report based on the adapted port number and the at least one lowest muted port index.

In some embodiments of the present disclosure, the at least one muted port comprises at least one set of muted ports, each of the at least one set of muted ports comprises one or more muted ports with consecution port indexes, and the lowest port index among the consecution port indexes is based on a respective one of the indicated at least one lowest muted port index; and wherein the number of the at least one muted port is based on the adapted port number.

In some embodiments of the present disclosure, the indication indicates at least one of the following: whether a type 1 or type 2 port adaptation is applied; or whether all, a part of, or none of the spatial elements associated with a port or a port group for the CSI report are disabled.

In some embodiments of the present disclosure, the processor is further configured to receive the CSI report after the port adaptation is applied. In some embodiments of the present disclosure, wherein an antenna element and port mapping of the CSI-RS resource associated with the CSI report is not changed after the port adaptation is applied; or wherein the CSI report is based on a time instance of the CSI-RS resource associated with the CSI report that occurs after the time when the port adaptation is applied in the case that the antenna element and port mapping of the CSI-RS resource associated with the CSI report is changed.

In some embodiments of the present disclosure, the processor is further configured to determine an adapted port number or a lowest muted port index based on the indication. In some embodiments of the present disclosure, the antenna element and port mapping of the CSI-RS resource associated with the CSI report is determined to be changed in response to at least one of the following: the number of ports for the CSI report is greater than the adapted port number, the maximum index of the ports for the CSI report is greater than or equal to the lowest muted port index. a type 2 port adaptation is applied, or a part of spatial elements associated with at least one of the ports for the CSI report is disabled.

Some embodiments of the present disclosure provide a method for wireless communication performed by a UE. The method may include: receiving a configuration associated with a channel state information (CSI) report, wherein the configuration indicates a number of ports for the CSI report; receiving an indication associated with port adaptation; and generating the CSI report based on the configuration and the indication.

Some embodiments of the present disclosure provide a method for wireless communication performed by a BS. The method may include: transmitting, to a user equipment (UE), a configuration associated with a channel state information (CSI) report, wherein the configuration indicates a number of ports for the CSI report; transmitting, to the UE, an indication associated with port adaptation; and transmitting, to the UE, a CSI reference signal (CSI-RS) on a CSI-RS resource for the CSI report in response to the port adaptation being applied, wherein the CSI-RS resource is determined based on the configuration and the indication.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-4 illustrate exemplary CSI-RS patterns in accordance with some embodiments of the present disclosure;

FIG. 5 illustrates a schematic diagram of CSI reference resource definitions in accordance with some embodiments of the present disclosure;

FIGS. 6 and 7 illustrate flow charts of exemplary procedures of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a dynamic adaptation of spatial elements is introduced into a communication system. For example, a dynamic adaptation of the port number can save the energy consumed by the network drastically. In some embodiments of the present disclosure, at least the following two port adaptation mechanisms are supported:
Type 1: enable or disable all spatial elements associated with a logical antenna port (may also referred to as “antenna port” or “port” in the context of the present disclosure for simplicity). For example, a subset of ports for a CSI-RS resource (e.g., 2 out of 4 ports for the CSI-RS resource), a specific synchronization signal block (SSB) with a specific SSB index, or both may be enabled or disabled.
Type 2: enable or disable of a part of spatial elements associated with a logical antenna port. This may result in changes to one or more of the antenna pattern, gains, transmission configuration indication (TCI) states, and the transmission power of the reference signal or channel that use the antenna port.

In the context of the present disclose, disabling all spatial elements associated with a port or disabling a port may be referred to as muting the port.

The above two types of adaptation may have different impacts. For example, in type 1 port adaptation, the mapping between antenna elements and some ports may be maintained, so the corresponding logical channel state may not be impacted. For example, in type 2 adaptation, the mapping between antenna elements and ports may be changed, so the logical channel state may always be changed. The adjustment of number of port or transmission reception point (TRP) is cell-specific behavior, and is common to all the UEs in the cell.

In some embodiments of the present disclosure, the number of ports of a CSI-RS resource may be semi-statically configured by radio resource control (RRC) signaling. For example, a BS may configure a configuration associated with a CSI report (e.g., via CSI-ReportConfig as specified in 3GPP specifications) to a UE. The configuration associated with the CSI report may indicate a resource for channel measurement (e.g., a CSI resource, which may be indicated by CSI-ResourceConfig as specified in 3GPP specifications). The CSI resource may indicate the port(s) of a CSI-RS resource. Thus, the dynamic port adaptation mechanism may have impacts on the CSI-RS and the associated CSI report.

In some embodiments of the present disclosure, a CSI-RS signal may be mapped to physical resources based on various parameters including the number of ports, density, code division multiplexing (CDM) types and CSI-RS locations within a slot. The number of ports, density, code division multiplexing (CDM) types may be configured by RRC. In some examples, these parameters may be specified in a predefined table. Below shows an example of such table.

The determination of row index in Table 1 may be determined by an RRC parameter (e.g., frequencyDomainAllocation as specified in 3GPP specifications) or a number of parameters (e.g., three parameters such as the number of ports, density, and CDM types). In some cases, when the three parameters are determined, the row index in the table used for CSI-RS mapping may be determined, which means that CSI-RS locations within a slot are determined. If there are multiple row index corresponds to the same parameters of the number of ports, density, and CDM types, the row with the lowest index may be selected.

TABLE 1
CSI-RS locations within a slot

| | Ports | Density | | | CDM group | | |
|---|---|---|---|---|---|---|---|
| Row | χ | ρ | cdm-Type | (k̅, l̅) | index j | k′ | l′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), | 0, 1, 2, 3 | 0, 1 | 0 |
| | | | | (k₃, l₀) | | | |
| 7 | 8 | 1 | fd-CDM2 | (k₀, l₀), (k₁, l₀), (k₀, l₀ + | 0, 1, 2, 3 | 0, 1 | 0 |
| | | | | 1), (k₁, l₀ + 1) | | | |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), | 0, 1, 2, 3, 4, 5 | 0, 1 | 0 |
| | | | | (k₃, l₀), (k₄, l₀), (k₅, l₀) | | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7 | | |
| | | | | (k₁, l₀ + 1), (k₂, l₀ + 1), | | | |
| | | | | (k₃, l₀ + 1) | | | |
| 12 | 16 | 1, 0.5 | cdm4-FD2- | (k₀, l₀), (k₁, l₀), (k₂, l₀), | 0, 1, 2, 3 | 0, 1 | 0, 1 |
| | | | TD2 | (k₃, l₀) | | | |
| 13 | 24 | 1, 0.5 | fd-CDM2 | (k₀, l₀), (k₁, l₀), (k₂, l₀), | 0, 1, 2, 3, 4, | 0, 1 | 0 |
| | | | | (k₀, l₀ + 1), (k₁, l₀ + 1), | 5, 6, 7, 8, 9, | | |
| | | | | (k₂, l₀ + 1), (k₀, l₁), (k₁, l₁), | 10, 11 | | |
| | | | | (k₂, l₁), (k₀, l₁ + 1), | | | |
| | | | | (k₁, l₁ + 1), (k₂, l₁ + 1) | | | |
| 14 | 24 | 1, 0.5 | cdm4-FD2- | (k₀, l₀), (k₁, l₀), (k₂, l₀), | 0, 1, 2, 3, 4, 5 | 0, 1 | 0, 1 |
| | | | TD2 | (k₀, l₁), (k₁, l₁), (k₂, l₁) | | | |
| 15 | 24 | 1, 0.5 | cdm8-FD2- | (k₀, l₀), (k₁, l₀), (k₂, l₀) | 0, 1, 2 | 0, 1 | 0, 1, |
| | | | TD4 | | | | 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7, | | |
| | | | | (k₁, l₀ + 1), (k₂, l₀ + 1), | 8, 9, 10, 11, | | |
| | | | | (k₃, l₀ + 1), (k₀, l₁), | 12, 13, 14, 15 | | |
| | | | | (k₁, l₁), (k₂, l₁), (k₃, l₁), | | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4-FD2- | (k₀, l₀), (k₁, l₀), (k₂, l₀), | 0, 1, 2, 3, 4, 5, | 0, 1 | 0, 1 |
| | | | TD2 | (k₃, l₀), (k₀, l₁), (k₁, l₁), | 6, 7 | | |
| | | | | (k₂, l₁), (k₃, l₁) | | | |
| 18 | 32 | 1, 0.5 | cdm8-FD2- | (k₀, l₀), (k₁, l₀), (k₂, l₀), | 0, 1, 2, 3 | 0, 1 | 0, 1, |
| | | | TD4 | (k₃, l₀) | | | 2, 3 |

The specific definitions of the parameters in the above table can be found in 3GPP specifications (e.g., 3GPP specification TS 38.211). It should be noted that the above table is only for illustrative purpose and other tables can also be employed.

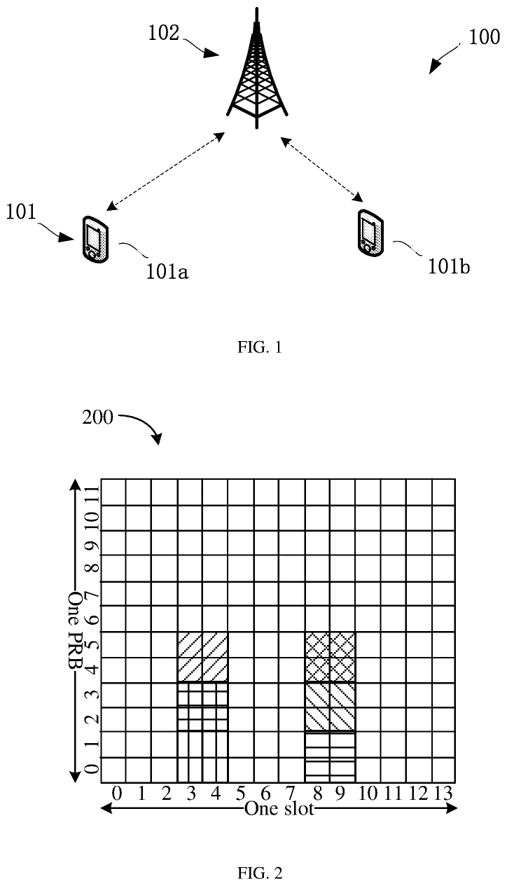

FIG. 2 illustrates an exemplary CSI-RS pattern 200 in accordance with some embodiments of the present disclosure. In the example of FIG. 2, it is assumed that a resource block (RB) includes 12 resource elements (REs) indexed from 0 to 11, and a slot includes 14 symbols indexed from 0 to 13.

In some examples, assuming that the row with the index of 14 in Table 1 is determined by a UE to determine the CSI-RS locations within a slot, the UE may determine CSI-RS pattern 200 as FIG. 2 (e.g., l₀=3 and l₁=8, and l̅ has two values corresponding to the values of l₀ and l₁). As shown in FIG. 2, the CSI-RSs may be positioned at 24 REs (i.e., REs 0 to 5 of symbol 3, 4, 8 and 9), and each RE may correspond to one port.

In some embodiments, for each CSI-RS configured, the UE may assume the sequence r(m) being mapped to resources elements (k,l)_{p.μ} according to, for example, the following formulas. The specific definitions of the parameters in the following formulas can be found in 3GPP specifications. It should be noted that the following formulas are only for illustrative purpose and other formulas can also be employed.

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} )$$

$${m}^{′} = ⌊ n α ⌋ + {k}^{′} + ⌊ \frac{\overline{k} ρ}{{N}_{sc}^{RB}} ⌋$$

$$k = {nN}_{sc}^{RB} + \overline{k} + {k}^{′}$$

$$l = \overline{l} + {l}^{′}$$

$$α = \{ \begin{matrix}ρ & for X = 1 \\ 2 ρ & for X > 1\end{matrix}$$

$$n = 0 , 1 , …$$

The sequence mapping to physical resources is related to, for example, the frequency domain location (k) and time domain location (l) of the corresponding CSI-RS. The port number (e.g., X) may also have impacts on the sequence. When one or more ports are muted, whether the CSI-RS pattern should be changed or not needs to be considered. In addition, the sequence mapping to physical resource may be also impacted.

After a CSI report is configured, a UE may perform CSI measurements on the corresponding CSI resources configured for the UE. For example, multiple DL CSI-RS or SSB at different time instances (e.g., CSI resource occasions) may be used for averaging the CSI measurement result.

However, instead of utilizing all CSI resource occasions, the UE may perform the CSI measurements based on a CSI reference resource. The CSI reference resource may be associated with the CSI reporting. For example, for a CSI report to be transmitted in an uplink slot, the corresponding CSI reference resource may be defined at a downlink slot which precedes and is based on the uplink slot. In some examples, only the CSI resource occasions preceding the corresponding CSI reference resource may be used for CSI measurement of the CSI report. The dynamic port adaptation mechanism may also have impacts on the CSI measurements as well as the CSI reporting.

Embodiments of the present disclosure provide solutions for solving the above issues. For example, since muting different port pattern can bring different performance, solutions for indicating the muted port pattern are provided. Since the dynamic port adaptation may impact the CSI measurement, solutions for enhancing the CSI measurement are provided. More details on the embodiments of the present disclosure will be illustrated in the following text in combination with the appended drawings.

FIG. 6 illustrates a flow chart of exemplary procedure 600 of wireless communications in accordance with some embodiments of the present disclosure. Procedure 600 may be implemented by a UE (e.g., UE 101 as shown in FIG. 1). Details described in all of the foregoing embodiments of the present disclosure are applicable for the embodiments shown in FIG. 6.

Referring to FIG. 6, in operation 611, a UE may receive a configuration associated with a CSI report from a BS (e.g., BS 102 as shown in FIG. 1), wherein the configuration indicates a number of ports for the CSI report. The number of ports for the CSI report means the port number of a CSI-RS resource indicated by the CSI resource. In operation 613, the UE may receive an indication (denoted as “indication #1” for clarity) associated with port adaptation.

In some examples, the configuration may be transmitted via an RRC message. In some examples, indication #1 may be indicated in a downlink control information (DCI) format.

In some embodiments of the present disclosure, the configuration indicates a plurality of CSI-RS resources with different numbers of ports for channel measurement for the CSI report. In some embodiments, one CSI-RS resource of the plurality of CSI-RS resources may be activated. In this case, the number of ports for the CSI report is the number of ports for the active CSI-RS resource.

In some embodiments of the present disclosure, the configuration indicates a plurality of CSI reports, each of which is configured with a CSI-RS with different numbers of ports for channel measurement. In some embodiments, one CSI report of the plurality of CSI reports may be activated. In this case, the number of ports for the CSI report is the number of ports for the active CSI report.

In some embodiments of the present disclosure, indication #1 indicates an adapted port number. In response to receiving indication #1, the UE may compare the adapted port number with the port number of an active CSI-RS resource or the port number of an active CSI report.

For example, the UE may determine whether the port number of an active CSI-RS resource or an active CSI report is greater than the adapted port number. In response to the port number of the active CSI-RS resource or the active CSI report being equal to or smaller than the adapted port number, the UE may maintain the active CSI-RS resource or the active CSI report. That is, the active CSI-RS resource or the active CSI report does not need to be changed in response to the port adaptation.

In response to the port number of the active CSI-RS resource or the active CSI report being greater than the adapted port number, the UE may deactivate the active CSI-RS resource or the active CSI report. The UE may activate a CSI-RS resource from the plurality of CSI-RS resources with the same number of port as the adapted port number; or the UE may activate a CSI report from the plurality of CSI reports with the same number of port as the adapted port number.

For example, the configuration may indicate CSI report #A1, CSI report #A2, and CSI report #A3, each of which is configured with a CSI-RS with different numbers of ports (e.g., 2, 4, and 8 ports respectively). In some examples, CSI report #A3 (8 ports) is activated. The UE may receive indication #1 indicating an adapted port number of 4. Then, the UE may deactivate CSI report #A3 and activate CSI report #A2.

For example, the configuration may indicate CSI-RS resource #B1 with 2 ports, CSI-RS resource #B2 with 4 ports, and CSI-RS resource #B3 with 8 ports for a CSI report. In some examples, CSI-RS resource #B2 is activated for the CSI report. The UE may receive indication #1 indicating an adapted port number of 4. Then, the UE may maintain the active CSI-RS resource #B2 (4 ports).

In some embodiments of the present disclosure, indication #1 indicates a CSI-RS resource from the plurality of CSI-RS resources or a CSI report from the plurality of CSI reports. The UE may activate the indicated CSI-RS resource or the indicated CSI report when the port adaptation is applied.

For example, the configuration may indicate CSI-RS resource #C1 with 2 ports, CSI-RS resource #C2 with 4 ports, and CSI-RS resource #C3 with 8 ports for a CSI report. The UE may receive indication #1 indicating CSI-RS resource #C1. Then, the UE may active CSI-RS resource #C1 at the time when the port adaptation is applied. In the case that the current active CSI-RS resource is CSI-RS resource #C1, the UE may not change the active CSI-RS resource.

In some embodiments of the present disclosure, indication #1 indicates at least one muted port.

In some embodiments of the present disclosure, indication #1 includes a plurality of bits, each of which corresponds to a port. For example, a maximum of 32 ports may be supported. Indication #1 may include 32 bits, each corresponding to one port of the 32 ports. For example, a bit value of “1” may indicate the corresponding port is not muted and a bit value of “0” may indicate the corresponding port is muted; or vice versa. In this way, the muted port can be determined based on indication #1.

In some embodiments of the present disclosure, indication #1 includes a plurality of bits, each of which corresponds to a port group. For example, the maximum of 32 ports can be grouped into a plurality of port groups. Each bit in indication #1 corresponds to one port group of the plurality of port groups. For example, a bit value of “1” may indicate ports in the corresponding port group are not muted and a bit value of “0” may indicate ports in the corresponding port are muted; or vice versa.

In some embodiments of the present disclosure, the port groups are determined based on a CDM group configuration for the CSI report. In some embodiments of the present disclosure, the port groups are predefined. In some embodiments of the present disclosure, the port groups are defined based on configurable port numbers.

For example, the CDM group configuration for the CSI report (e.g., corresponding to “cdm-Type” in Table 1) may be noCDM, fd-CDM2, cdm4-FD2-TD2, or cdm8-FD2-TD4, which may respectively suggest 1, 2, 4, or 8 ports can be grouped into one group. For example, it is assumed that a maximum of 32 ports is supported, the 32 ports are indexed from 0 to 31, and the CDM group configuration is “cdm4-FD2-TD2,” 8 port groups each including consecutive port indexes, i.e., {0-3}, {4-7}, {8-11}, {12-15}, {16-19}, {20-23}, {24-27}, and {28-31}, can be determined. Indication #1 may include 8 bits, each corresponding to one of the 8 port groups.

In the case of “noCDM,” since only one port is in each group, it also suggest that the ports are not grouped, and thus each bit in indication #1 corresponds to one port. As an alternative, when the CDM group configuration for the CSI report is “noCDM” (e.g., cdm-Type configured by RRC is “noCDM”), an addition indication may be transmitted to the UE from the BS to indicate the size of a port group (or indication #1 may include an addition field to indicate the group size), and each bit in indication #1 corresponds to a port group.

It should be noted that other indexing methods can be employed. For example, the above port indexes (e.g., from 0 to 32) can be defined as the port number (e.g., as specified in TS 38.211 and starts from 3000).

For example, the ports can be grouped based on the difference between two adjacent configurable port numbers. It is assumed that the port numbers that can be configured for a UE (i.e., configurable port numbers) may be 1, 2, 4, 8, 12, 16, 24, and 32. The differences between two adjacent configurable port numbers are 1, 2, 4, 4, 4, 8, and 8. Since there are a maximum of 32 ports, the number of ports in the plurality of port groups can be is 1, 1, 2, 4, 4, 4, 8, and 8. Assuming that the maximum of 32 ports are indexed from 0 to 31, 8 ports, i.e., {0}, {1}, {2-3}, {4-7}, {8-11}, {12-15}, {16-23}, and {24-31}, can be determined.

In some examples, the configurable port numbers are predefined. Therefore, in these examples, the port groups being defined based on configurable port numbers can be deemed as a special case of the port groups being predefined.

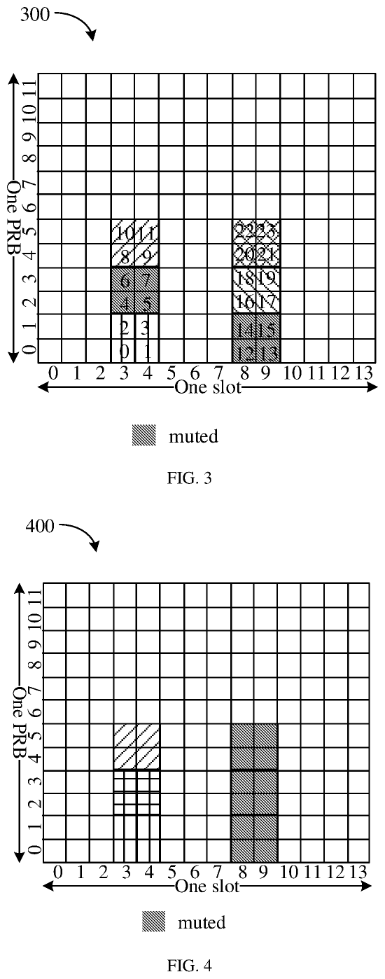

FIG. 3 illustrates an exemplary CSI-RS pattern 300 in accordance with some embodiments of the present disclosure. CSI-RS pattern 300 is a CSI-RS pattern based on CSI-RS pattern 200 in FIG. 2 and after a port adaption is applied.

For example, assuming that a UE determines that the row with the index of 14 in Table 1 is used to determine the CSI-RS locations within a slot and the UE receives indication #1 indicating that ports {4-7} and {12-15} are muted, the UE may determine CSI-RS pattern 300 as shown in FIG. 3. Referring to FIG. 3, REs 0 to 5 of symbol 3, 4, 8 and 9 corresponds to 24 ports for channel measurement indexed from 0 to 23, and ports {4-7} and {12-15} are muted.

In some embodiments of the present disclosure, certain ports may be refrained from being muted. This can eliminate the impacts on CSI-RS resource configured with less port number. For example, indication #1 may only indicate whether certain ports (e.g., ports 4-31 out of ports 0-31) are muted or not. For example, in the case that a maximum of 32 ports (e.g., indexed as ports 0-31) are supported, the ports may be grouped into {4-7} {8-11} {12-15} {16-23} {24-31}, thereby the port(s) of a CSI-RS resource configured with a port number of 1, 2, 3, or 4 may always not be muted.

In some embodiments of the present disclosure, indication #1 indicates at least one symbol which a muted port(s) is associated with.

In some embodiments of the present disclosure, indication #1 may indicate at least one of: an index(es) of the at least one symbol; a value of a first symbol in time domain parameter (e.g., l₀ or l₁ as defined in 3GPP specifications and as shown in Table 1) associated with the CSI report; or a value of a start symbol position parameter (e.g., l̅ as defined in 3GPP specifications and as shown in Table 1) associated with the CSI report.

In some embodiments of the present disclosure, two values (e.g., l₀ or l₁) may be configured for the “first symbol in time domain parameter” via RRC. For example, RRC parameters firstOFDMSymbolInTimeDomain and firstOFDMSymbolInTimeDomain2 may respectively configure the values of l₀ and l₁. The start symbol position parameter (e.g., l̅) may be based on the values of the first symbol in time domain parameter. For example, as shown in row 14 of Table 1, l̅ may equal to l₀ or l₁.

In some embodiments of the present disclosure, the UE may determine at least one of: a port(s) which locates in a symbol(s) having the indicated index(es) is muted; a port(s) in a CDM group associated with the value of the first symbol in time domain parameter is muted; or a port(s) in a CDM group starting from the start symbol position is muted.

FIG. 4 illustrates an exemplary CSI-RS pattern 400 in accordance with some embodiments of the present disclosure. CSI-RS pattern 400 is a CSI-RS pattern based on CSI-RS pattern 200 in FIG. 2 and after a port adaption is applied.

For example, in some embodiments, a UE may determine that the row with the index of 14 in Table 1 is used to determine the CSI-RS locations within a slot and may receive indication #1 indicating symbols 8 and 9, the UE may determine that ports located in symbols 8 and 9 are muted as shown in FIG. 4.

For example, in some embodiments, a UE may determine that the row with the index of 14 in Table 1 is used to determine the CSI-RS locations within a slot and may receive indication #1 indicating the value of l₁ (e.g., symbol 8), the ports in CDM groups starting from symbol 8 are muted as shown in FIG. 4.

For example, in some embodiments, a UE may determine that the row with the index of 14 in Table 1 is used to determine the CSI-RS locations within a slot. There may be two values (e.g., l₀ and l₁ in row 14 in Table 1) for l̅. If l₀ is configured as symbol 3 and l₁ is configured as symbol 8 (as shown in FIG. 2), the two values for l̅ are symbol 3 and symbol 8. When the UE receives indication #1 indicating the value of l̅ (e.g., symbol 8), the ports in CDM groups starting from symbol 8 are muted as shown in FIG. 4.

In some embodiments of the present disclosure, indication #1 indicates an adapted port number and at least one lowest muted port index. In some embodiments of the present disclosure, the UE may determine at least one muted port for the CSI report based on the adapted port number and the at least one lowest muted port index. For example, the UE can determine the number of muted ports based on the adapted port number and can determine which ports are muted based on the at least one lowest muted port index.

For example, in some embodiments of the present disclosure, the at least one muted port may include at least one set of muted ports, each of the at least one set of muted ports may include one or more muted ports with consecution port indexes, and the lowest port index among the consecution port indexes is based on a respective one of the indicated at least one lowest muted port index. The number of the at least one muted port is based on the adapted port number.

For example, it is assumed that the maximum port number is 32 and the adapted port number is 24. The UE determines that the number of the muted ports is 8. In the case that indication #1 indicates only one lowest port index, the muted ports are continuous 8 ports counting up from the indicated lowest port index. In the case that indication #1 indicates multiple lowest port indexes, the muted ports are continuous N ports counting up from each of the lowest port indexes. The value of N can be determined by the number of the lowest port indexes and the number of the muted ports. For example, N=(the number of the muted ports)/(the number of the lowest port indexes).

For example, assuming that a UE determines that the row with the index of 14 in Table 1 is used to determine the CSI-RS locations within a slot and receives indication #1 indicating an adapted port number of 16 and two lowest muted port indexes of 4 and 12, the UE may determine CSI-RS pattern 300 in FIG. 3 after the port adaptation is applied.

In some embodiments of the present disclosure, indication #1 indicates an adapted port number and at least one highest muted port index. In some embodiments of the present disclosure, the UE may determine at least one muted port for the CSI report based on the adapted port number and the at least one highest muted port index. For example, the UE can determine the number of muted ports based on the adapted port number and can determine which ports are muted based on the at least one highest muted port index.

For example, in some embodiments of the present disclosure, the at least one muted port may include at least one set of muted ports, each of the at least one set of muted ports may include one or more muted ports with consecution port indexes, and the highest port index among the consecution port indexes is based on a respective one of the indicated at least one highest muted port index. The number of the at least one muted port is based on the adapted port number.

For example, it is assumed that the maximum port number is 32 and the adapted port number is 24. The UE determines that the number of the muted ports is 8. In the case that indication #1 indicates only one highest port index, the muted ports are continuous 8 ports counting down from the indicated highest port index. In the case that indication #1 indicates multiple highest port indexes, the muted ports are continuous N′ ports counting down from each of the highest port indexes. The value of N′ can be determined by the number of the highest port indexes and the number of the muted ports. For example, N′=(the number of the muted ports)/(the number of the highest port indexes).

In some embodiments of the present disclosure, the CSI-RS pattern after the application of the port adaptation can follow the one before the port adaptation, but there is no CSI-RS sequence transmitted on the REs corresponding to the muted ports. For example, as shown in FIGS. 3 and 4, the REs labelled as muted are not used for CSI-RS transmission. In some embodiments of the present disclosure, CSI-RS sequence generation can be based on the adapted port number or the port number before adapted (e.g., the value of X in aforementioned formulas). The sequence mapping to physical resources may not be changed.

In some embodiments of the present disclosure, the CSI-RS pattern may be changed after the application of the port adaptation, for example, the network may apply a new CSI-RS pattern based on Table 1 shown above. The sequence mapping to physical resources is thus generated based on the new frequency and time domain position(s).

In some embodiments of the present disclosure, indication #1 may indicate at least one of the following: whether a type 1 or type 2 port adaptation is applied; or whether all, a part of, or none of the spatial elements associated with a port or a port group for the CSI report are disabled.

In some embodiments of the present disclosure, the port groups may be determined based on a CDM group configuration for the CSI report; or the port groups are predefined; or the port groups are defined based on configurable port numbers.

For example, at least one bit in indication #1 may be used to indicate whether a type 1 or type 2 port adaptation is applied. For example, indication #1 may further include one or more bits to indicate the muted port pattern as described above (e.g., indicating adapted port number, muted port indexes, or the like). In the case that type 2 port adaptation is applied, the remaining bits in indication #1 may be reserved. That is, in the case that type 2 port adaptation is applied, the channel state is bound to change.

For example, a codepoint of indication #1 may be used to indicate that whether type 2 port adaptation is applied. The remaining codepoints of indication #1 may be used to indicate the muted port pattern.

For example, it is assumed that a maximum of 32 ports is supported, the 32 ports are indexed from 0 to 31, and the CDM group configuration is “cdm4-FD2-TD2,” 8 port groups, i.e., {0-3}, {4-7}, {8-11}, {12-15}, {16-19}, {20-23}, {24-27}, and {28-31}, can be determined. For each port group, indication #1 may include at least two bits to indicate whether all, a part of, or none of the spatial elements associated with ports in a corresponding port group are disabled. In this sense, the port adaptation has a unified structure where type 1 adaptation and type 2 adaptation can be used jointly.

As mentioned above, a CSI reference resource is defined with respect to the CSI report. Based on the CSI reference resource, the UE can determine the time instances of the CSI-RS resource that are used for averaging the CSI measurement result, thereby generating the CSI report. However, in some cases, the application of the port adaptation may cause a change in the antenna element and port mapping of the CSI-RS resource associated with the CSI report. In such cases, certain time instances of the CSI-RS resource may become invalid, which may have impacts on the CSI report which is transmitted after the application of the port adaptation. The UE may determine whether the CSI report is influenced by the application of the port adaptation and may act accordingly.

For example, in operation 615, the UE may generate the CSI report based on the configuration and indication #1.

In some embodiments of the present disclosure, generating the CSI report based on the configuration and indication #1 may include at least one of the following: (1) in the case that an antenna element and port mapping of a CSI-RS resource associated with the CSI report is not changed after the port adaptation is applied, maintaining the CSI report to be transmitted after the port adaptation is applied; (2) in the case that all time instances of the CSI-RS resource associated with the CSI report precedes a time when the port adaptation is applied and the antenna element and port mapping of the CSI-RS resource associated with the CSI report is changed after the port adaptation is applied, dropping the CSI report to be transmitted after the port adaptation is applied; or (3) in the case that the antenna element and port mapping of the CSI-RS resource associated with the CSI report is changed after the port adaptation is applied, generating the CSI report to be transmitted after the port adaptation is applied based on a time instance of the CSI-RS resource associated with the CSI report that occurs after the time when the port adaptation is applied.

In case (1), the CSI report transmitted after the application of the port adaptation is not impacted since the antenna element and port mapping of the CSI-RS resource associated with the CSI report is not changed after the application of the port adaptation. In case (2), since the antenna element and port mapping of the CSI-RS resource associated with the CSI report is changed after the application of the port adaptation and all time instances of the CSI-RS resource associated with the CSI report precedes the time when the port adaptation is applied, the CSI report no long reflect the current channel state and thus become invalid. In case (3), although the antenna element and port mapping of the CSI-RS resource associated with the CSI report is changed after the application of the port adaptation, since certain time instances of the CSI-RS resource associated with the CSI report occurs after the time when the port adaptation is applied, these time instances can be used for generating the CSI report.

Various methods may be employed to determine whether the antenna element and port mapping of the CSI-RS resource associated with the CSI report is changed or not after port adaptation is applied.

For example, in some embodiments of the present disclosure, the UE may determine an adapted port number or the lowest muted port index based on indication #1. For example, according to the various embodiments and implementations of indication #1 as mentioned above, the UE can determine an adapted port number or the lowest muted port index for the port adaptation.

The antenna element and port mapping of the CSI-RS resource associated with the CSI report is determined to be changed in response to at least one of the following: the number of ports for the CSI report is greater than the adapted port number; the maximum index of the ports for the CSI report is greater than or equal to the lowest muted port index; a type 2 port adaptation is applied (e.g., type 2 port adaptation is applied to at least one of the ports for the CSI report); or a part of spatial elements associated with at least one of the ports for the CSI report is disabled.

In some embodiments of the present disclosure, the antenna element and port mapping of the CSI-RS resource associated with the CSI report may be determined to be unchanged in response to: the number of ports for the CSI report is equal to or smaller than the adapted port number; or the maximum index of the ports for the CSI report is smaller than the lowest muted port index;

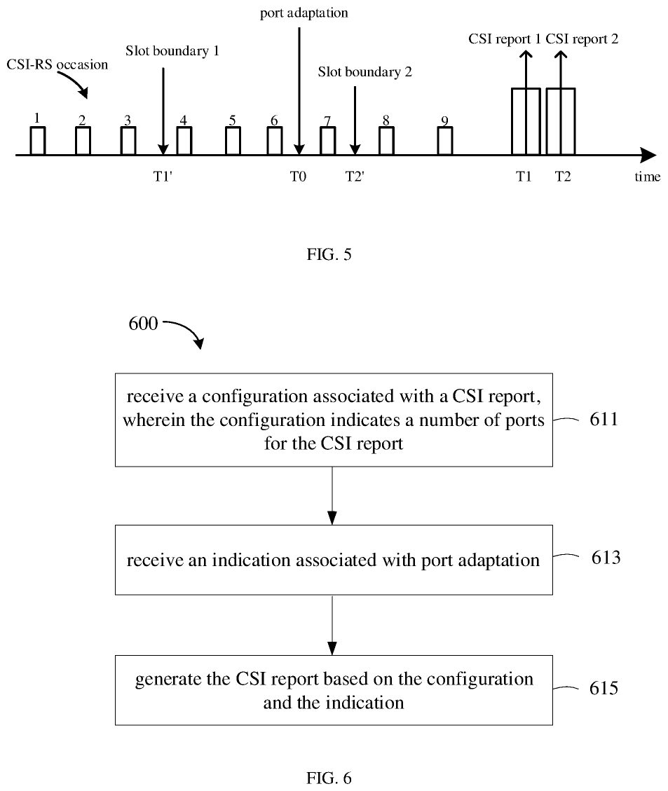

For example, referring to FIG. 5, the UE may need to transmit CSI reports 1 and 2 at times T1 and T2, respectively. The slot boundary (e.g., slot boundary 1 in FIG. 5) of the CSI reference source for CSI report 1 may be defined at time T1′. The slot boundary (e.g., slot boundary 2 in FIG. 5) of the CSI reference source for CSI report 2 may be defined at time T2′. The time instances of the CSI-RS resource associated with CSI report 1 may include CSI-RS occasions 1 to 3. The time instances of the CSI-RS resource associated with CSI report 2 may include CSI-RS occasions 4 to 7. A port adaption may occur at time T0.

In some examples, in the case that the port number of the CSI-RS for CSI report 1 is larger than the adapted port number, CSI report 1 will be dropped (belongs to in case (2)). In the case that the port number of the CSI-RS for CSI report 1 is not larger than the adapted port number, CSI report 1 is not impacted by the port adaptation (belongs to in case (1)).

In some examples, in the case that the port number of the CSI-RS for CSI report 2 is larger than the adapted port number, only the CSI-RS occasions (e.g., CSI-RS occasion 7) after the time point is valid (belongs to in case (3)). In the case that the port number of the CSI-RS for CSI report 2 is not larger than the adapted port number, the CSI-RS occasions (e.g., CSI-RS occasion 4, 5, 6, 7) no matter after or before T0 is valid for the CSI report (belongs to in case (1)).

It should be appreciated by persons skilled in the art that the sequence of the operations in exemplary procedure 600 may be changed and some of the operations in exemplary procedure 600 may be eliminated or modified, without departing from the spirit and scope of the disclosure.

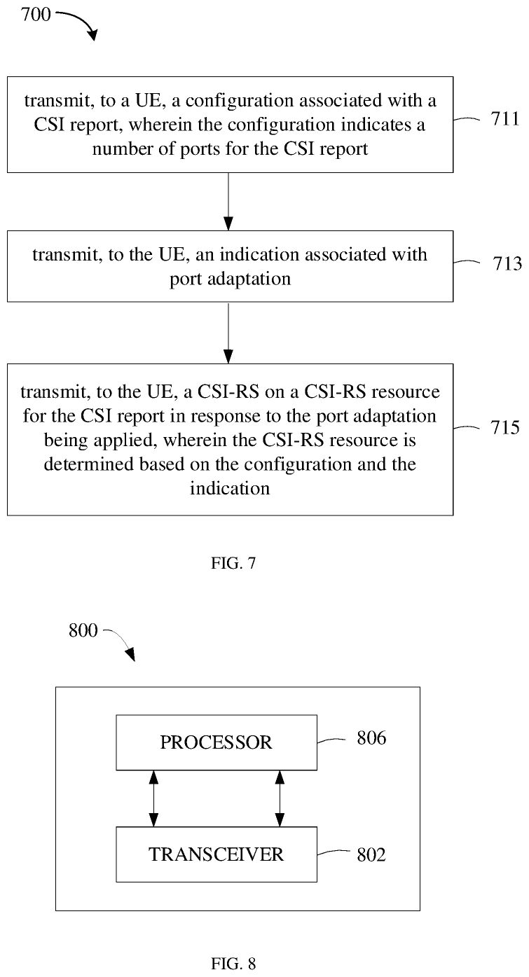

FIG. 7 illustrates a flow chart of an exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS, for example, BS 102 in FIG. 1.

Referring to FIG. 7, in operation 711, a BS may transmit, to a UE, a configuration associated with a CSI report, wherein the configuration indicates a number of ports for the CSI report. In operation 713, the BS may transmit, to the UE, an indication (e.g., indication #1) associated with port adaptation.

In operation 715, the BS may transmit, to the UE, a CSI-RS on a CSI-RS resource for the CSI report in response to the port adaptation being applied, wherein the CSI-RS resource is determined based on the configuration and the indication

The descriptions regarding the configuration and indication #1 in the forgoing embodiments may apply here.

For example, in some embodiments of the present disclosure, the configuration indicates a plurality of CSI-RS resources with different numbers of ports for channel measurement for the CSI report or a plurality of CSI reports, each of which is configured with a CSI-RS with different numbers of ports for channel measurement, and the indication indicates an adapted port number.

In some embodiments of the present disclosure, the BS may perform at least one of the following: in response to the port adaptation being applied, determine whether a port number of an active CSI-RS resource or an active CSI report for the UE is greater than the adapted port number; in response to the port number of the active CSI-RS resource or the active CSI report for the UE being equal to or smaller than the adapted port number, maintain the active CSI-RS resource or the active CSI report for the UE; in response to the port number of the active CSI-RS resource or the active CSI report for the UE being greater than the adapted port number, deactivate the active CSI-RS resource or the active CSI report for the UE; or in response to the port number of the active CSI-RS resource or the active CSI report for the UE being greater than the adapted port number, activate a CSI-RS resource for the UE from the plurality of CSI-RS resources with the same number of port as the adapted port number, or activate a CSI report for the UE from the plurality of CSI reports with the same number of port as the adapted port number.

For example, in some embodiments of the present disclosure, the configuration indicates a plurality of CSI-RS resources with different numbers of ports for channel measurement for the CSI report or a plurality of CSI reports, each of which is configured with a CSI-RS with different numbers of ports for channel measurement, and the indication indicates a CSI-RS resource from the plurality of CSI-RS resources or a CSI report from the plurality of CSI reports.

In some embodiments of the present disclosure, transmitting the CSI-RS includes transmitting the CSI-RS on the indicated CSI-RS resource or on a CSI-RS resource for the indicated CSI report.

For example, in some embodiments of the present disclosure, the indication indicates at least one muted port.

In some embodiments of the present disclosure, the indication includes a plurality of bits, each of which corresponds to a port.

In some embodiments of the present disclosure, the indication includes a plurality of bits, each of which corresponds to a port group. In some embodiments of the present disclosure, the port groups are determined based on a CDM group configuration for the CSI report; or the port groups are predefined; or the port groups are defined based on configurable port numbers.

For example, in some embodiments of the present disclosure, the indication indicates at least one symbol which a muted port(s) is associated with. In some embodiments of the present disclosure, the indication indicates at least one of: an index(es) of the at least one symbol; a value of a first symbol in time domain parameter associated with the CSI report; or a value of a start symbol position parameter associated with the CSI report.

In some embodiments of the present disclosure, the BS may determine at least one of: a port(s) which locates in a symbol(s) having the indicated index(es) is muted; a port(s) in a CDM group associated with the value of the first symbol in time domain parameter is muted; or a port(s) in a CDM group starting from the start symbol position is muted

For example, in some embodiments of the present disclosure, the indication indicates an adapted port number and at least one lowest (or highest) muted port index. In some embodiments of the present disclosure, the BS may determine at least one muted port for the CSI report based on the adapted port number and the at least one lowest (or highest) muted port index.

In some embodiments of the present disclosure, the at least one muted port includes at least one set of muted ports, each of the at least one set of muted ports includes one or more muted ports with consecution port indexes, and the lowest (or highest) port index among the consecution port indexes is based on a respective one of the indicated at least one lowest (or highest) muted port index; and the number of the at least one muted port is based on the adapted port number.

For example, in some embodiments of the present disclosure, the indication indicates at least one of the following: whether a type 1 or type 2 port adaptation is applied; or whether all, a part of, or none of the spatial elements associated with a port or a port group for the CSI report are disabled.

In some embodiments of the present disclosure, the BS may receive the CSI report after the port adaptation is applied, wherein an antenna element and port mapping of the CSI-RS resource associated with the CSI report is not changed after the port adaptation is applied. In some embodiments of the present disclosure, the BS may receive the CSI report after the port adaptation is applied, wherein the CSI report is based on a time instance of the CSI-RS resource associated with the CSI report that occurs after the time when the port adaptation is applied in the case that the antenna element and port mapping of the CSI-RS resource associated with the CSI report is changed.

In some embodiments of the present disclosure, the BS may determine an adapted port number or a lowest muted port index based on the indication. The antenna element and port mapping of the CSI-RS resource associated with the CSI report is determined to be changed in response to at least one of the following: the number of ports for the CSI report is greater than the adapted port number, the maximum index of the ports for the CSI report is greater than or equal to the lowest muted port index, a type 2 port adaptation is applied, or a part of spatial elements associated with at least one of the ports for the CSI report is disabled.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement the method with respect to the BS as described above. For example, the computer-executable instructions, when executed, cause the processor 806 interacting with transceiver 802 to perform the operations with respect to the BS described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a configuration associated with a channel state information (CSI) report, wherein the configuration indicates a number of ports for the CSI report;
receive an indication associated with port adaptation; and
generate the CSI report based on the configuration and the indication.

2. The UE of claim 1, wherein the configuration indicates a plurality of CSI reference signal (CSI-RS) resources with different numbers of ports for channel measurement for the CSI report or a plurality of CSI reports, each of which is configured with a CSI-RS with different numbers of ports for channel measurement, and the indication indicates an adapted port number.

3. The UE of claim 2, wherein the at least one processor is configured to cause the UE to:
determine whether a port number of an active CSI-RS resource or an active CSI report is greater than the adapted port number;
in response to the port number of the active CSI-RS resource or the active CSI report being equal to or smaller than the adapted port number, maintain the active CSI-RS resource or the active CSI report;
in response to the port number of the active CSI-RS resource or the active CSI report being greater than the adapted port number, deactivate the active CSI-RS resource or the active CSI report; or
in response to the port number of the active CSI-RS resource or the active CSI report being greater than the adapted port number, activate a CSI-RS resource from the plurality of CSI-RS resources with the same number of port as the adapted port number, or activate a CSI report from the plurality of CSI reports with the same number of port as the adapted port number.

4. The UE of claim 1, wherein the configuration indicates a plurality of CSI reference signal (CSI-RS) resources with different numbers of ports for channel measurement for the CSI report or a plurality of CSI reports, each of which is configured with a CSI-RS with different numbers of ports for channel measurement, and the indication indicates a CSI-RS resource from the plurality of CSI-RS resources or a CSI report from the plurality of CSI reports.

5. The UE of claim 4, wherein the at least one processor is configured to cause the UE to activate the indicated CSI-RS resource or the indicated CSI report when the port adaptation is applied.

6. The UE of claim 1, wherein the indication indicates at least one muted port.

7. The UE of claim 6, wherein the indication comprises a first plurality of bits, each of which corresponds to a port; or
wherein the indication comprises a second plurality of bits, each of which corresponds to a port group.

8. The UE of claim 7, wherein the port groups are determined based on a code division multiplexing (CDM) group configuration for the CSI report;
wherein the port groups are predefined; or
wherein the port groups are defined based on configurable port numbers.

9. The UE of claim 1, wherein the indication indicates an adapted port number and at least one lowest muted port index.

10. The UE of claim 9, wherein the at least one processor is configured to cause the UE to determine at least one muted port for the CSI report based on the adapted port number and the at least one lowest muted port index.

11. The UE of claim 10, wherein the at least one muted port comprises at least one set of muted ports, each of the at least one set of muted ports comprises one or more muted ports with consecution port indexes, and the lowest port index among the consecution port indexes is based on a respective one of the indicated at least one lowest muted port index; and
wherein the number of the at least one muted port is based on the adapted port number.

12. The UE of claim 1, wherein the indication indicates at least one of the following:
whether a type 1 or type 2 port adaptation is applied; or
whether all, a part of, or none of spatial elements associated with a port or a port group for the CSI report are disabled.

13. The UE of claim 1, wherein generating the CSI report based on the configuration and the indication comprises at least one of the following:
if an antenna element and port mapping of a CSI reference signal (CSI-RS) resource associated with the CSI report is not changed after the port adaptation is applied, maintaining the CSI report to be transmitted after the port adaptation is applied;
if all time instances of the CSI-RS resource associated with the CSI report precedes a time when the port adaptation is applied and the antenna element and port mapping of the CSI-RS resource associated with the CSI report is changed after the port adaptation is applied, dropping the CSI report to be transmitted after the port adaptation is applied; or
if the antenna element and port mapping of the CSI-RS resource associated with the CSI report is changed after the port adaptation is applied, generating the CSI report to be transmitted after the port adaptation is applied based on a time instance of the CSI-RS resource associated with the CSI report that occurs after the time when the port adaptation is applied.

14. A base station (BS), comprising:
at least one memory; and
at least one processor coupled with the at least one memory and configured to cause the base station to:
transmit, to a user equipment (UE), a configuration associated with a channel state information (CSI) report, wherein the configuration indicates a number of ports for the CSI report;
transmit, to the UE, an indication associated with port adaptation; and
transmit, to the UE, a CSI reference signal (CSI-RS) on a CSI-RS resource for the CSI report in response to the port adaptation being applied, wherein the CSI-RS resource is determined based on the configuration and the indication.

15. A method performed by a user equipment (UE), the method comprising:
receiving a configuration associated with a channel state information (CSI) report, wherein the configuration indicates a number of ports for the CSI report;
receiving an indication associated with port adaptation; and
generating the CSI report based on the configuration and the indication.

16. A processor for wireless communication, comprising:
at least one controller coupled with at least one memory and configured to cause the processor to:
receive a configuration associated with a channel state information (CSI) report, wherein the configuration indicates a number of ports for the CSI report;
receive an indication associated with port adaptation; and
generate the CSI report based on the configuration and the indication.

17. The processor of claim 16, wherein the configuration indicates a plurality of CSI reference signal (CSI-RS) resources with different numbers of ports for channel measurement for the CSI report or a plurality of CSI reports, each of which is configured with a CSI-RS with different numbers of ports for channel measurement, and the indication indicates an adapted port number.

18. The processor of claim 17, wherein the at least one controller is configured to cause the processor to:
determine whether a port number of an active CSI-RS resource or an active CSI report is greater than the adapted port number;
in response to the port number of the active CSI-RS resource or the active CSI report being equal to or smaller than the adapted port number, maintain the active CSI-RS resource or the active CSI report;
in response to the port number of the active CSI-RS resource or the active CSI report being greater than the adapted port number, deactivate the active CSI-RS resource or the active CSI report; or
in response to the port number of the active CSI-RS resource or the active CSI report being greater than the adapted port number, activate a CSI-RS resource from the plurality of CSI-RS resources with the same number of port as the adapted port number, or activate a CSI report from the plurality of CSI reports with the same number of port as the adapted port number.

19. The processor of claim 16, wherein the configuration indicates a plurality of CSI reference signal (CSI-RS) resources with different numbers of ports for channel measurement for the CSI report or a plurality of CSI reports, each of which is configured with a CSI-RS with different numbers of ports for channel measurement, and the indication indicates a CSI-RS resource from the plurality of CSI-RS resources or a CSI report from the plurality of CSI reports.

20. The processor of claim 19, wherein the at least one controller is configured to cause the processor to activate the indicated CSI-RS resource or the indicated CSI report when the port adaptation is applied.
